(19) United States
(12) Patent Application Publication
(10) Pub. No.: US 2005/0231899 A1
(43) Pub. Date: Oct. 20, 2005

(54) Device carrying system

(75) Inventors: Stacey Alan Barnes, Round Rock, TX (US); Viktors Berstis, Austin, TX (US)

Correspondence Address: Robert V. Wilder;Attorney at Law, 4235 Kingsburg Drive, Round Rock, TX, 78681, US

(73) Assignee: International Business Machines Corporation, Armonk, NY (US)

(21) Appl. No.: 10/824,990

(22) Filed: Apr. 15, 2004

(51) Int. Cl. G06F 1/16

(52) U.S. Cl. 361/683

(57) ABSTRACT

A method and implementing system are provided for enabling the carrying of a portable computer or similar electronic device along with one or more accessory devices in a single package which uses an accessory device to form a handle by which the electronic device may be carried. In one example, an AC power adapter cord is embedded within a carrying strap and the computer is designed to use attachment devices for securing the carrying strap around the computer casing. The carrying strap is also used to form a handle for carrying the portable computer and the AC power adapter cord together as a single package. In another embodiment, the carrying strap is “U” shaped and comprised of a series of sections to fit snugly around the outside edge of a laptop computer. In another example, a computer security cable is used in a similar manner to form a handle for carrying the computer together with the security cable. In another example, the AC power adapter cord is modified to act as a security cable for the portable computer and is also designed to form a carrying handle for the computer when the computer is being carried.

### FIELD OF THE INVENTION

The present invention relates generally to portable electronic devices and more particularly to a methodology and implementation for facilitating the carrying of portable computers and related attachments.

### BACKGROUND OF THE INVENTION

Laptop computers are used extensively today in both business and home situations. One of the most desirable attributes of the laptop computer is its light weight and portability. However, in view of the many attachments and accessories which are designed to enhance the functionality of laptops, most users typically must carry many of the accessories and attachments along with the laptop when the user brings the laptop to a meeting or a workplace. For example, at a minimum, a user must carry the laptop along with a power cord and an AC or power adapter. However, since the adapter and other attachments are bulky and awkward to carry, the user will bring along a separate computer carrying case which is itself an added accessory. Many times the computer case is used to carry papers and a user will carry the laptop under the user's arm, since most laptops have no handle, while holding the computer case with the user's hands, thereby risking accidentally dropping and damaging the laptop. Building retractable handles into a laptop is not a satisfactory solution in most cases since a retractable handle takes away from the limited available space inside the laptop which is needed for the electronics. Moreover, even when a handle is built-in, there is no additional padding and the power cord and power adapter are still a problem when trying to carry a laptop computer.

A security cable lock is another separate accessory which may be useful to bring to a meeting. A laptop or notebook computer security cable is designed to attach at one end to a laptop anchor point or built-in security slot, typically a recess in the laptop casing, and at the other end to an immovable or large object such as the leg of large conference table . This arrangement is designed to secure the laptop computer if the user needs to leave the room without taking along his or her laptop. However, the security cable is another item which must be carried along with the laptop if it is to be used at the meeting.

Thus, there is a need for an improved methodology and system for facilitating the carrying of a laptop computer or other portable electronic device.

### SUMMARY OF THE INVENTION

A method and implementing system are provided for enabling the carrying of a portable computer or similar electronic device along with one or more accessory devices in a single package which uses an accessory device to form a handle by which the electronic device may be carried. In one example, an AC power adapter cord is embedded within a carrying strap and the computer is designed to use attachment devices for securing the carrying strap around the computer casing. The carrying strap is also used to form a handle for carrying the portable computer and the AC power adapter cord together as a single package. In another embodiment, the carrying strap is “U” shaped and comprised of a series of sections to fit snugly around the outside edge of a laptop computer. In another example, a computer security cable is used in a similar manner to form a handle for carrying the computer together with the security cable. In another example, the AC power adapter cord is modified to act as a security cable for the portable computer and is also designed to form a carrying handle for the computer when the computer is being carried.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration showing an exemplary arrangement of an AC adapter, an associated power adapter cord and a laptop computer;

FIG. 2 is an illustration showing various exemplary attachment points for attaching the AC power cord and adapter around the edge of a laptop computer;

FIG. 3 is a partial perspective view of one corner of a laptop showing details of one exemplary attachment methodology in accordance with one embodiment of the present invention;

FIG. 4 is a partial perspective view of one corner of a laptop showing details of a second exemplary attachment methodology in accordance with one embodiment of the present invention;

FIG. 5 is a partial perspective view of one corner of a laptop showing details of one implementation for embedding an AC power adapter within a padded belt or carrying strap which is selectively attached around the edges of a laptop in accordance with one embodiment of the present invention;

FIG. 6 is a partial perspective view of one corner of a laptop showing details of a security anchor recess which is built into the laptop;

FIG. 7 is a partial perspective view of one corner of a laptop showing details of an alternate implementation for placement of the AC power cord or security cable around the edges of a laptop computer;

FIG. 8 is an illustration showing an exemplary arrangement for modification of the adapter cord to enable the adapter power cord to also be used as a security cable for the laptop;

FIG. 9 is another embodiment of the present invention in which the carrying strap is made-up of sections of pre-formed “U”-shaped padded material which can be arranged to fit snugly around the outer edge of a laptop computer;

FIG. 10 is a detailed illustration of the “U” shaped strap around the edge of a laptop computer;

FIG. 11 is an illustration showing the U-shaped strap when it is extended for connection to a power outlet; and

FIG. 12 is an illustration showing conductor wires within the padded material.

### DETAILED DESCRIPTION

It is noted that devices which are shown in block form in the drawings are generally known to those skilled in the art, and are not specified to any greater extent than that considered necessary as illustrated, for the understanding and appreciation of the underlying concepts of the present invention and in order not to obfuscate or distract from the teachings of the present invention. Although the present invention is herein disclosed using a personal laptop computer in the example, it is understood that the invention applies as well to any portable electronic device which may be used with one or more accessory devices.

In an exemplary embodiment of the present invention, a laptop computer uses a modified AC power adapter cord which is attachable around the edges of the laptop and forms a handle by which the laptop computer, together with the AC power adapter and cord, may be carried. It is noted that because of recent technology advancements, both the laptop computer and the adapter have been significantly reduced in size and weight. For example some laptops today are close to two pounds in weight and power adapters are approaching the size of a matchbox with a corresponding reduction in weight. Thus, in one exemplary embodiment of the present invention, the AC power adapter and cord are selectively and removably attachable to one or more attachment points along the edge of a laptop computer, and the cord itself is used to form a handle by which the laptop may be carried.

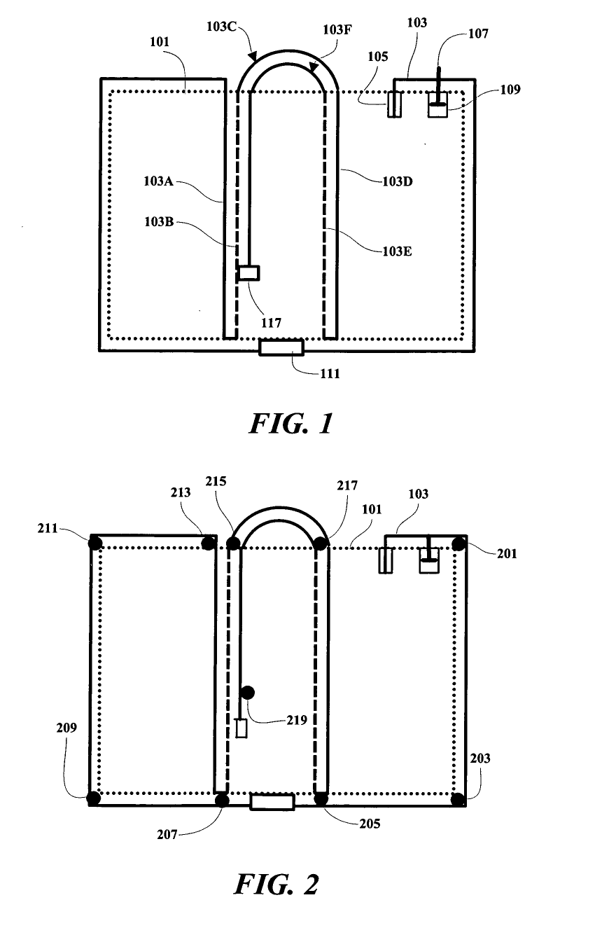

FIG. 1 is an illustration showing an exemplary arrangement in which an adapter and adapter cord are embedded within a carrying strap which is wrapped around the outer edges of a laptop computer and arranged to form a carrying handle for the laptop. As shown, a laptop computer 101, includes a top panel, a bottom panel, and four side panels or edges as is well known. Laptop computer 101 is illustrated in phantom lines in FIG. 1 in order to highlight an exemplary wrapping pattern of the AC power adapter cord around the side panels or edges of the laptop 101. Throughout this disclosure, even though the example shows the AC adapter cord or cable embedded in a carrying strap to wrap around the laptop, it is understood that the methodology also applies to other cable accessories including, but not limited to, a security cable accessory, a network connection cable accessory or a universal serial bus (USB) cable connector accessory. For example, a security cable, either in place of or in addition to the AC adapter cord, may be used to wrap around the edges of a laptop and form a carrying handle. In FIG. 1, a cable accessory which is illustrated as an AC adapter cord 103, which may or may not be embedded within a carrying strap, is shown plugged into a power input terminal 105. The cord 103 as shown also includes an attachment 107 which is anchored to a security recess 109 in the laptop 101 and used to provide stress relief for the cord connection 105 and also to secure the adapter cord to the laptop 101. The adapter cord 103, which in one example is embedded in a carrying strap as discussed below, is wrapped around and secured to the laptop 101 at various points around the edges of the laptop 101 as illustrated in connection with FIG. 2. An AC adapter 111 for the laptop 101 is shown as embedded within the carrying strap adapter cord for the laptop 101.

As noted above, in one example, the adapter cord is modified by being embedded within a support or carrying nylon strap which is secured around the edges of the laptop 101. The carrying strap which includes the power cord, is also padded for added mechanical protection for the laptop. In one example, the first several feet of the power cord from its connection to the laptop is designed to include four nylon-padded “U”-shaped padded material sections which wrap around the edges of the laptop. In another example, the adapter cord is embedded in a continuous nylon belt or carrying strap arrangement designed to wrap around the laptop. Thus, in its modified form, the adapter cord strap performs the functions of support for the laptop as well as providing padding protection and an electrical connection for the computer. When the carrying strap is further reinforced with a security cable, the carrying strap performs the function of providing a security anchor as well.

As illustrated in FIG. 1, the cord 103 wraps around one side or edge of the laptop immediately adjacent to the anchor recess 109, and then continues along the bottom edge of the laptop 101. The cord 103 is connected to an AC adapter 111 and the cord on the DC side of the adapter 111 is extended around the edge of the laptop to the top of the laptop where the cord is secured to the laptop before it is routed downwardly 103A around the bottom of the laptop and up the other side 103B to the top of the laptop 101 where it forms one portion of a handle-shaped extension 103C. The cord 103 is then again secured to the laptop after forming the handle-shaped arrangement 103C and is extended downwardly along the front side 103D of the laptop. The cord then extends underneath the laptop and up the opposite side 103E again to the top of the laptop where it forms a second handle-shaped segment 103F which corresponds to the first handle 103C. The cord 103 then is again secured to the laptop and extends downwardly where the electrical plug 117 for connection to an AC outlet is secured to the laptop by, for example, a Velcro™ patch, so that it will remain relatively immovable while the laptop is being carried. When the cord 103 is arranged as shown in FIG. 1, the laptop may be carried by using the handle sections 103C and 103F of the cord 103, which, in one embodiment, may be embedded within a carrying belt or strap.

The arrangement of the wrapping around the laptop 101 in FIG. 1 is only one example of many possible wrapping arrangements and it is understood that the exact wrapping arrangement may be in many other patterns around the laptop in order to provide a handle and provide support for the laptop while it is being carried.

FIG. 2 illustrates several attachment points along the outer edges of the laptop 101 to which attachment devices may be secured. In the example, the attachment devices are comprised of matching pieces or layers of a hook and loop material such as Velcro™ material. In the example, Velcro™ materials are cemented or otherwise permanently attached to the laptop at the attachment points where corresponding Velcro™ attaching pads, which are part of the adapter cord or carrying strap, will be placed in contact. Velcro™ material is preferred because it is light in weight, relatively inexpensive and readily available and also because its holding strength is sufficient for the purposes disclosed herein. It is understood, however, that other attachment devices or schemes may also be implemented in practicing the present invention. As shown in FIG. 2, attachment points 201, 203, 205, 207, 209, 211, 213, 215, 217 and 219 are generally positioned around the outer edges of the laptop 101 along the path of the adapter cord or carrying strap 103. In the example, Velcro™ material is placed at the attachment points to hold and secure the cord or carrying strap to the laptop at the attachment points. It is understood that there may be more or fewer attachment points in any particular embodiment of the present invention and the number and location of the attachment points will vary depending upon, inter alia, the size and weight of the laptop, the carrying strap and the adapter, and whether or not a reinforcing security cable is included with the carrying strap.

The plug end 219 of the cable may also be placed in a straight line and attached by Velcro™ material to the carrying strap or tucked within a pocket on the strap which runs from point 213 to point 207. with this embodiment, there would be no need to have Velcro™ material placed on the laptop at all and the carrying strap would be arranged around the laptop computer and secured to itself after being wrapped around the computer.

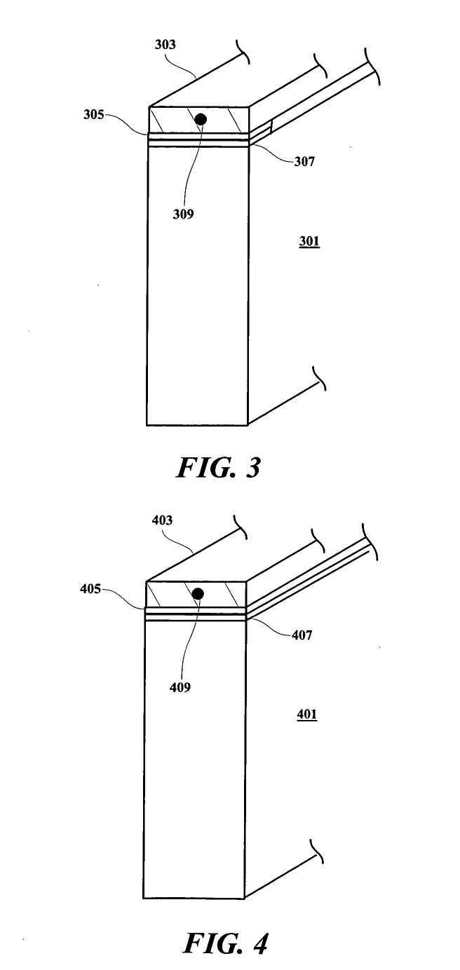

In FIG. 3, there is shown a corner of a laptop computer 301 which illustrates a carrying strap 303. The carrying strap 303 has an adapter cord 309 embedded within the strap 303. The carrying strap also includes a Velcro™ pad 305 which is arranged to come into contact with a matching Velcro™ attaching pad 307 positioned on the laptop 301. In the embodiment of FIG. 3, the carrying strap 303 is attached to the laptop 301 by means of a plurality of matching Velcro™ pads placed at various points around the edge of the laptop 301.

FIG. 4 illustrates a corner of a laptop 401 including a carrying strap or belt 403 which has an adapter cord 409 embedded therein. Also shown is a first Velcro™ layer 405 permanently attached to the carrying belt 403 and a second Velcro™ layer 407 which is permanently attached to the laptop 401. The attaching layers are designed to run along the entire edge or edges of the laptop 401, rather than at separate points as shown in FIG. 3, in order to provide added holding strength where needed in certain applications.

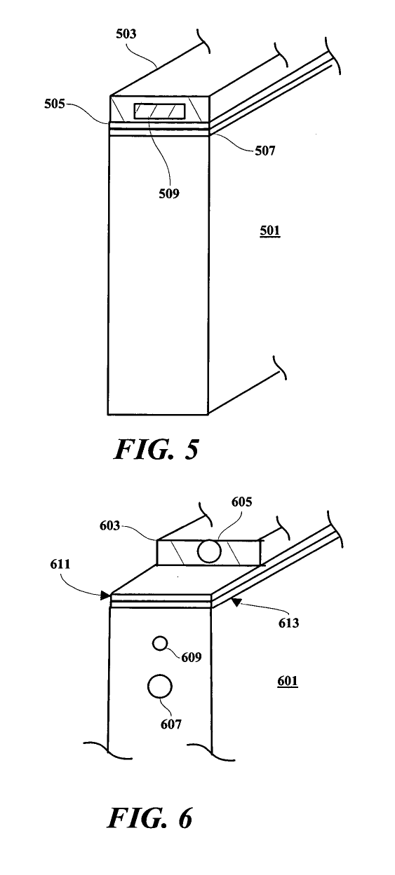

In FIG. 5, there is shown a corner section of a laptop computer 501 including a carrying strap 503 and Velcro™ layers 505 and 507. FIG. 5 illustrates how the AC adapter 509 is embedded within the carrying strap 503, which is, in turn, attached to the laptop 501 when the carrying strap and the handle arrangements shown in FIG. 1 are used to carry the laptop. In certain applications, the layer arrangement of the Velcro™ material may be used to attach to the carrying strap at points proximate to the adapter (205, 207) and also at points adjacent to the carrying handles (215, 217) while the individual pad arrangement of Velcro™ material may be used at other locations along the edges of the laptop where added attachment strength may not be required.

FIG. 6 illustrates the portion of a laptop computer 601 which includes the electrical connection receptacle 607 which is arranged to receive the DC side of the adapter cord. Also shown is the security anchor recess 609 which is arranged to have a security anchor device (such as 107 in FIG. 1) inserted therein. Velcro™ layers 611 and 613 attach the carrying strap 603, which includes the adapter cord 605, to the laptop 601. It is here noted that, as a design option, a separate security cable could be substituted for or added to the adapter cord 605 within the carrying strap 603.

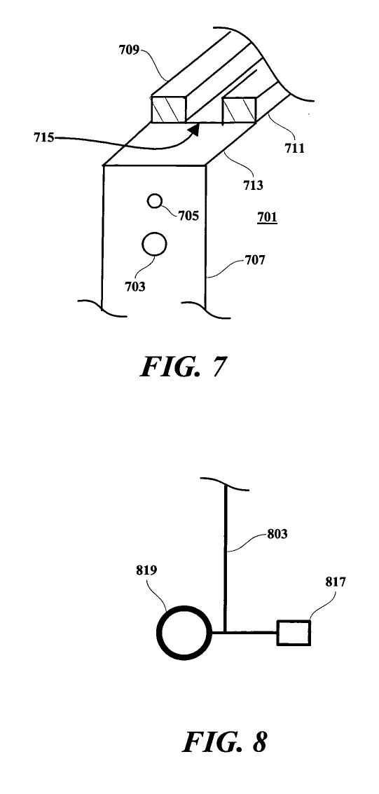

FIG. 7 shows an alternate arrangement in which a laptop computer 701 includes a security anchor recess 705 and an electrical receptacle 703. Also shown are guide strips of material 709 and 711 which are cemented to or otherwise permanently attached to the sides 713 of the laptop 701 to define a carrying groove or slot 715 in which the adapter cord and/or security cable may be placed. The strips 709 and 711 may be made of any relatively rigid material, including but not limited to a high density foam material, padded nylon strips, or plastic or metal strips which would be rigid enough to hold the adapter cord and/or security cable in the carrying slot 715 when the adapter cord and/or security cable is arranged as shown in FIG. 1 and used to carry the laptop 701. It should be noted that for laptop implementations including the guide strips 709 of FIG. 7 or the Velcro™ layers as shown in FIGS. 5 and 6 where attachment devices are cemented to the laptop, the placement of the strips and layers on the laptop is determined so as not to interfere with other functional areas on the sides of the laptop such as the disk drive, PCI card devices and/or connector receptacles or sockets. Accordingly, it is preferred that spot patches of ™ materials can be used in certain areas along the edge of a laptop where drives and terminal receptacles are located while layers of limited but continuous extent can be used in other edge areas where there are no interfering devices in order to provide a stronger attachment to the laptop.

FIG. 8 illustrates an adapter cord 803 including an end plug 817, similar to that shown as 103 and 117 in FIG. 1, and further including a security attachment 819. The security attachment 819 is a metal locking ring or loop which is permanently attached to the adapter cord 803. The locking ring or loop 819 includes a hole which is sufficiently large as to allow the adapter cord and adapter to be passed therethrough after being tied around the leg of a conference table for example. The other end of the cord 803 is locked into the anchor or locking recess 109 of the laptop computer. In this manner, the adapter cord/carrying strap is used to form a handle to carry the laptop and is also used to provide a security locking device to secure the laptop when the user needs to leave the room without the laptop. Many other specific implementations are also possible in order to provide the function by which a laptop computer adapter cord may also be used as a carrying handle and also a security device to lock and secure the laptop computer to a relatively stationary object.

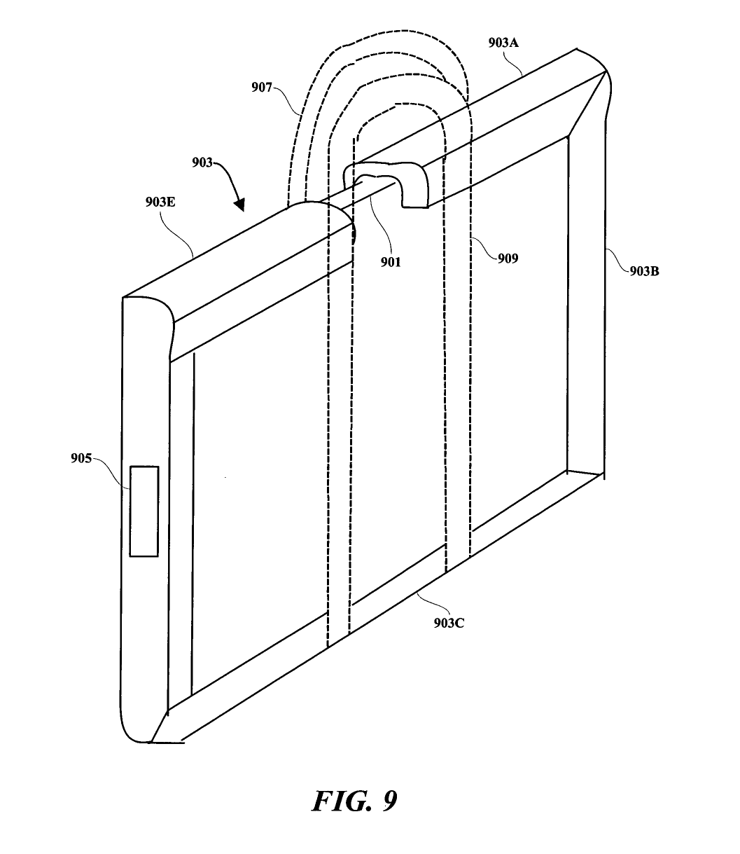

In FIG. 9, there is shown a laptop computer 901, the outer edges of which are enclosed by a padded material U-shaped sleeve 903 which is comprised of, for example, five sections 903A, 903B, 903C, 903D and 903E. The five sections are joined together and may be positioned to overlap the edges of the laptop 901 as shown. The AC adapter cord (not shown) is designed into the sectionalized padding 903. A pocket or compartment 905 is designed into the sleeve section 903D, or another section as may be desired, and may be used to place the AC adapter and/or the AC power plug and/or a security cable end loop. Carrying straps 907 and 909 are also attached to the carrying sleeve 903 and may be used to carry the laptop. When the present invention is implemented as shown in FIG. 9, there is no need to use Velcro™ strips on the outer edges of the laptop computer since the pre-formed U-shaped sleeve will fit snugly around the outer edges of any laptop computer.

In FIG. 10, the pre-formed U-shaped material 903, including electrical conductors 921 and 923, is shown schematically as it is placed to overlap the outer edges of a laptop computer 901.

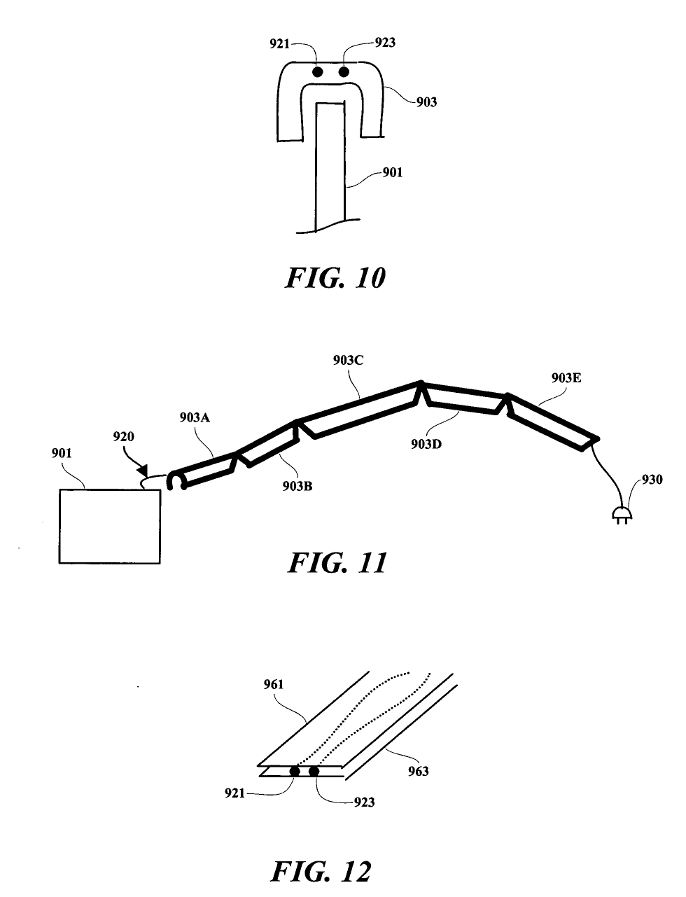

FIG. 11 shows the sleeve sections 903A-903E extended away from the laptop 901 and used for connecting to an AC power source. The sleeve includes a terminal at one end 920 for connection to the laptop 901, and an AC power plug 930 at the other end for connection to an AC power source.

As shown in FIG. 12, the electrical conductors 921 and 923 between the top sleeve cover sections 961 and 963 are longer in length than the sleeve section in which the conductors are placed so that when the sleeve sections are placed on the laptop, the sleeve sections will prevent the imposition of any stress on the electrical conductors.

The method and apparatus of the present invention has been described in connection with a preferred embodiment as disclosed herein. The disclosed methodology may be implemented in a wide range of implementations using one or more of many available materials suitable for the purposes described to accomplish the desired results as herein illustrated. Although an embodiment of the present invention has been shown and described in detail herein, along with certain variants thereof, many other varied embodiments that incorporate the teachings of the invention may be easily constructed by those skilled in the art. Accordingly, the present invention is not intended to be limited to the specific form set forth herein, but on the contrary, it is intended to cover such alternatives, modifications, and equivalents, as can be reasonably included within the spirit and scope of the invention.

1. A method for enabling an accessory cable for an electronic device to be used for carrying said electronic device, said method comprising:
attaching a first portion of said accessory cable to said electronic device on a first side of said electronic device;
wrapping said accessory cable around a bottom side of said electronic device; and
attaching a second portion of said accessory cable to said electronic device at first and second attachment points on a top side of said electronic device, said first and second attachment points being located to enable a handle to be formed by said accessory cable between said first and second attachment points, said handle being arranged as a hand-grip to enable a user to hand-carry said electronic device by said handle formed by said accessory cable.

2. The method as set forth in claim 1 wherein said electronic device is a laptop computer.

3. The method as set forth in claim 1 wherein said accessory cable is a cord for an AC adapter used with said electronic device.

4. The method as set forth in claim 1 wherein said accessory cable is a security cable apparatus used with said electronic device.

5. The method as set forth in claim 1 wherein said accessory cable is a network connector cable designed for use with said electronic device.

6. (canceled)

7. The method as set forth in claim 1 wherein said accessory cable is enclosed within a flat belt-shaped strap, said strap being designed to provide additional support for said electronic device.

8. The method as set forth in claim 7 wherein said strap is attached to said electronic device using a selectively detachable hook and loop material.

9. The method as set forth in claim 7 wherein said accessory cable is attached to said electronic device using a selectively detachable hook and loop material.

10. The method as set forth in claim 1 wherein said accessory cable is attached to said electronic device using a selectively detachable hook and loop material.

11. The method as set forth in claim 1 wherein said first portion of said accessory cable comprises an electrical power connection to said electronic device.

12. The method as set forth in claim 1 wherein said first portion of said accessory cable comprises a security connection device arranged for connection to a security recess within said electronic device.

13. An electronic device comprising:
an outer casing having a top panel, a bottom panel and four side panels;
attachment material disposed on said panels, said attachment material being designed to be selectively coupled to a cable accessory for said electronic device at two or more points on said top panel thereby enabling a carrying handle to be formed by said cable accessory, said cable accessory being arranged to provide bottom panel support for said electronic device, said carrying handle being arranged to snuggly engage with user's hand, said cable accessory thereby providing both bottom panel support for said electronic device and a carrying handle whereby said electronic device may be carried by a user using said carrying handle formed by said cable accessory.

14. The electronic device as set forth in claim 13 wherein said attachment material is a selectively detachable hook and loop material having a hooking surface and a corresponding loop surface.

15. The electronic device as set forth in claim 14 wherein said hooking surface is permanently attached to said panels and said corresponding loop surface is permanently attached to said cable accessory.

16. The electronic device as set forth in claim 14 wherein said hooking surface is permanently attached to said cable accessory and said corresponding loop surface is permanently attached to said panels.

17. The electronic device as set forth in claim 13 wherein said attachment material is in the form of a flat belt permanently attached at points around outer edges of said side panels of said electronic device.

18. The electronic device as set forth in claim 13 wherein said electronic device includes a security recess for receiving a security connector of a cable accessory for said electronic device.

19. An accessory strap for enclosing AC power conductors, said accessory strap comprising a series of two or more pre-formed sections, said pre-formed sections being arranged to enclose electrical conductors used to connect said electronic device to a power source, said accessory strap being designed to be selectively placed around a bottom portion of said electronic device, said accessory strap further including means for forming a carrying handle along a top portion of said electronic device, said accessory strap thereby providing both a carrying handle and bottom support for said electronic device whereby said electronic device may be carried by said carrying handle when said accessory strap is arranged around said bottom portion of said electronic device.

20. The accessory strap as set forth in claim 19 wherein said pre-formed sections are formed in a “U” shape to selectively fit snugly around outer edges of said electronic device.

21. The accessory strap as set forth in claim 20 wherein said electronic device is a laptop computer device.

22. The accessory strap as set forth in claim 21 wherein said electrical conductors are longer in length than said accessory strap whereby said accessory strap is effective to prevent mechanical stress being placed on said electrical conductors when said accessory strap is used to carry said laptop computer device.

23. A carrying system for a laptop computer, said carrying system comprising:
a laptop computer including an outer casing having a top panel, a bottom panel and four side panels;
attachment material disposed on said panels;
a selectively detachable power cable assembly for connecting said laptop computer to a power source, said attachment material being designed to be selectively coupled to said power cable assembly for said laptop computer at two or more points on said top panel thereby enabling a carrying handle to be formed by said power cable assembly, said power cable assembly being configured to provide bottom panel support for said laptop computer, said carrying handle being arranged to snuggly engage with user's hand, said power cable assembly thereby providing both bottom panel support for said electronic device and a carrying handle whereby said laptop computer may be hand-carried by a user using said carrying handle formed by said power cable assembly, said attachment material comprising a selectively detachable hook and loop material having a hooking surface and a corresponding loop surface, said attachment material being formed to comprise a flat belt permanently attached at points around outer edges of said side panels of said laptop computer, said power cable assembly comprising a series of “U” shaped sections designed to fit snugly around outer edges of said laptop computer while engaging with said attachment material.
